(19) United States
(12) Patent Application Publication
(10) Pub. No.: US 2025/0156407 A1
(43) Pub. Date: May 15, 2025

(54) QUERY PROCESSING METHOD BASED ON LARGE LANGUAGE MODEL, PROMPT CONSTRUCTION METHOD, ELECTRONIC DEVICE, AND STORAGE MEDIUM

(71) Applicant: Beijing Baidu Netcom Science Technology Co., Ltd., Beijing (CN)

(72) Inventors: Shaozhen GENG, Beijing (CN); Jun ZHANG, Beijing (CN)

(21) Appl. No.: 18/749,175

(22) Filed: Jun. 20, 2024

(30) Foreign Application Priority Data
Nov. 13, 2023 (CN) 202311507880.7

(51) Int. Cl. G06F 16/242; G06F 16/2457

(52) U.S. Cl. CPC G06F 16/2425; G06F 16/24575

(57) ABSTRACT

Provided are a query processing method based on a large language model, a prompt construction method, an electronic device, and a storage medium. The query processing method includes acquiring a to-be-processed target query; acquiring a data field in a target data model and acquiring target format information of a specified data format; constructing a prompt based on the data field in the target data model, the target format information, and the target query; and inputting the prompt into the large language model to obtain a target format result outputted by the large language model.

### CROSS-REFERENCE TO RELATED APPLICATION(S)

This application claims priority to Chinese Patent Application No. 202311507880.7 filed with the China National Intellectual Property Administration (CNIPA) on Nov. 13, 2023, the disclosure of which is incorporated herein by reference in its entirety.

### TECHNICAL FIELD

The present disclosure relates to the field of artificial intelligence such as deep learning and natural language processing, particularly a query processing method based on a large language model, a prompt construction method, an electronic device, and a storage medium.

### BACKGROUND

A large language model (LLM), a generative language model characterized by a large size, has a substantial number of parameters and extensive training data. By leveraging more parameters and larger datasets for training, the performance and sample efficiency of an LLM in various downstream tasks are effectively enhanced.

However, results returned by large models exhibit divergence and uncertainty, failing to satisfy requirements in certain scenarios.

### SUMMARY

The present disclosure provides a query processing method based on a large language model, a prompt construction method, an electronic device, and a storage medium.

According to an aspect of the present disclosure, a query processing method based on a large language model is provided. The method includes acquiring a to-be-processed target query; acquiring a data field in a target data model and acquiring target format information of a specified data format; constructing a prompt based on the data field in the target data model, the target format information, and the target query; and inputting the prompt into the large language model to obtain a target format result outputted by the large language model.

According to an aspect of the present disclosure, a prompt construction method is provided. The method includes acquiring a to-be-processed target query; acquiring a data field in a target data model and acquiring target format information of a specified data format; and constructing a prompt based on the data field in the target data model, the target format information, and the target query.

According to an aspect of the present disclosure, an electronic device is provided. The electronic device includes at least one processor and a memory communicatively connected to the at least one processor.

The memory stores instructions executable by the at least one processor to enable the at least one processor to perform the method of any embodiment of the present disclosure.

According to an aspect of the present disclosure, a non-transitory computer-readable storage medium is provided. The storage medium stores computer instructions for causing a computer to perform the method of any embodiment of the present disclosure.

It is to be understood that the content described in this part is neither intended to identify key or important features of embodiments of the present disclosure nor intended to limit the scope of the present disclosure. Other features of the present disclosure are apparent from the description provided hereinafter.

### BRIEF DESCRIPTION OF DRAWINGS

The drawings are intended to provide a better understanding of the technical solutions and not to limit the present disclosure.

FIG. 1 is a flowchart of a query processing method based on a large language model according to an embodiment of the present disclosure.

FIG. 2 is another flowchart of a query processing method based on a large language model according to an embodiment of the present disclosure.

FIG. 3A is a flowchart of a query processing method based on a large language model according to an embodiment of the present disclosure.

FIG. 3B is a diagram illustrating the structure of a prompt according to an embodiment of the present disclosure.

FIG. 4 is a diagram illustrating the structure of a prompt according to an embodiment of the present disclosure.

FIG. 5 is a flowchart of a prompt construction method according to an embodiment of the present disclosure.

FIG. 6 is a block diagram of a query processing apparatus based on a large language model according to an embodiment of the present disclosure.

FIG. 7 is a block diagram of a query processing apparatus based on a large language model according to an embodiment of the present disclosure.

FIG. 8 is a block diagram of an electronic device for implementing a query processing method based on a large language model or a prompt construction method according to an embodiment of the present disclosure.

### DETAILED DESCRIPTION

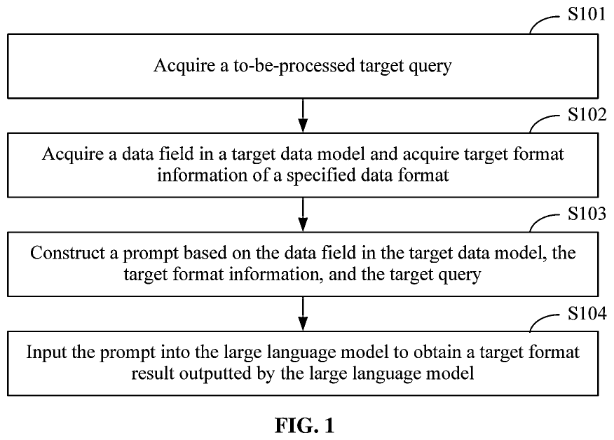

FIG. 1 is a flowchart of a query processing method based on a large language model according to an embodiment of the present disclosure. The method is applicable to prompt engineering of a large language model. The method can be executed by a query processing apparatus based on a large language model. The apparatus can be implemented by software and/or hardware and can be integrated into an electronic device. As shown in FIG. 1, the query processing method based on a large language model according to this embodiment may include the following:

In S101, a to-be-processed target query is acquired.

In S102, a data field in a target data model is acquired, and target format information of a specified data format is acquired.

In S103, a prompt is constructed based on the data field in the target data model, the target format information, and the target query.

In S104, the prompt is input into the large language model to obtain a target format result outputted by the large language model.

The prompt is a statement provided for the large language model. The prompt may be a given query, task, or instruction and is used for guiding a language generation process of the model. The content of the prompt depends on a user need and the task type. A data model is used for describing, organizing, or manipulating data. A data model may be viewed as simplification and abstraction of the real world to describe entities, attributes, and relationships between entities. It is feasible to select preconstructed data tables as the target data model and make the large language model to parse the target query into the specified data format based on the target data model.

A data field in the target data model may be a dimension or a measure in the target data model. The dimension is used for describing the attribute or the characteristic of data. The dimension is used for grouping, classifying, filtering, and screening data. The dimension provides context and classification for data, and typically has discrete values. The measure is an assessment of an operational indicator. The measure is used for evaluating, calculating, and analyzing the numerical indicator or calculation result of data. The measure typically consists of continuous numerical values, has calculability, and can be aggregated, computed, and statistically analyzed. For example, the target data model may include at least one of the following dimensions: order number, order date, region, province, city, product name, product category, product subcategory, customer name, customer type code, shipping date, or mailing method. The target data model may also include at least one of the following measures: quantity, sales amount, cost, or profit. The specified data format may be a fixed serialized format. The target format information of the specified data format is used for describing the specified data format.

The prompt may be constructed based on the data field in the target data model, the target format information, and the target query. By introducing the data field of the target data model into the prompt, the large language model can establish a relationship between the target query and the data field. By introducing the target format information of the specified data format into the prompt, the large language model converts the target query into the specified data format. The target format result in the specified data format may be used to query the target data model to obtain an answer to the target query, that is, the target format result may be used as a bridge between the large language model and the target data model, thereby facilitating parsing of the target format result. Therefore, by using the prompt formed by multiple parts, the large language model understands the meaning of the target query and generates the target format result in the specified data format.

In one or more embodiments, the target format result is configured for establishment of a relationship between the target query and the data field in the target data model, and the target format result is a serialized result.

The specified serialized format may be a specified JavaScript Object Notation (JSON) format. The target format result may be a result in the specified JSON format. Thus, the large language model can convert the target query into a result in the specified JSON format based on the data field in the target data model. For example, the target query “sales amount in January this year” may be converted into the following:

{“dimensions”:[ ],“measures”:[“sales amount”],“filters”:[{“k”:“order
date”,“linkType”:“between”,“v”:[“2023-01-01”,“2023-01-31”]}]}.

The operation of converting the target query into the target format result in the specified serialized format may be used for querying the target data model to get the answer to the target query so that the target format result can serve as a bridge between the large language model and the target data model, thereby facilitating parsing of the target format result.

In the technical solution of this embodiment of the present disclosure, an engineered prompt is constructed so that the large language model can learn through the provided prompt, establish a relationship between the target query and the target data model, and output the target format result in the specified serialized format based on the relationship. That is, the prompt engineering enables the large language model to process the target query into the serialized target format result by using the data field in the target data model, thereby improving the format stability of the target format result output by the large language model. The serialized target format result can be used for querying the target data model to get the answer to the target query so that the target format result can serve as a bridge between the large language model and the target data model, thereby facilitating parsing of the target format result.

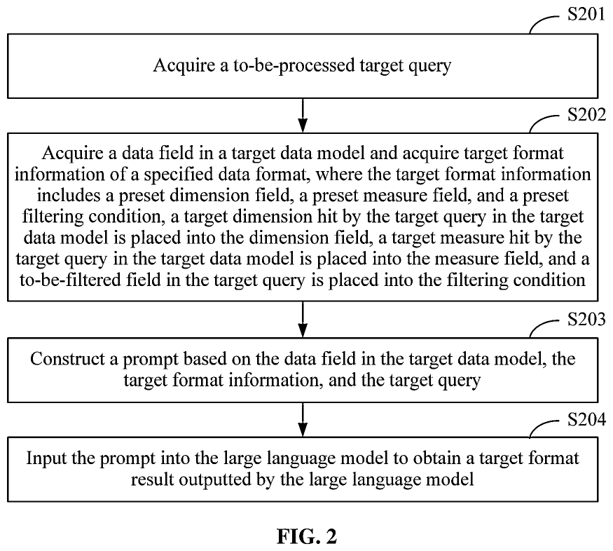

FIG. 2 is a flowchart of a query processing method based on a large language model according to an embodiment of the present disclosure. Referring to FIG. 2, the method for training a smart customer service model according to this embodiment may include the following: In S201, a to-be-processed target query is acquired.

In S202, a data field in a target data model is acquired, and target format information of a specified data format is acquired. The target format information includes a preset dimension field, a preset measure field, and a preset filtering condition. A target dimension hit by the target query in the target data model is placed into the dimension field. A target measure hit by the target query in the target data model is placed into the measure field. A to-be-filtered field in the target query is placed into the filtering condition.

In S203, a prompt is constructed based on the data field in the target data model, the target format information, and the target query.

In S204, the prompt is input into the large language model to obtain a target format result outputted by the large language model.

The target format information of the specified data format may include a format description of the specified data format. The format description of the specified data format may include a preset dimension field “dimensions”, a preset measure field “measures”, and a preset filtering condition “filters”. The target query may be matched with the dimension and the measure in the target data model to obtain the target dimension and the target field that are hit by the target query and also obtain a filtering condition. The filtering condition may include a to-be-filtered dimension and/or a to-be-filtered measure. The filtering condition may also be referred to as a screening condition.

In this embodiment of the present disclosure, the target dimension hit by the target query in the target data model may be placed in the field “dimensions”, the target measure hit by the target query in the target data model may be placed in the field “measures”, and the to-be-filtered field in the target query may be placed in the filtering condition “filters”. The format description of the specified data format is incorporated in the prompt so that the large language model can perform prompt learning based on the format description of the specified data format and convert the target query into the specified data format.

In one or more embodiments, the filtering condition uses an array structure, and the filtering condition comprises a preset first subfield, a preset second subfield, and a preset third subfield. The first subfield is configured to represent the to-be-filtered field, the second subfield is configured to represent a filtering value used by the to-be-filtered field, and the third subfield is configured to represent an operator of the filtering condition.

The filtering condition has three elements: a to-be-filtered field, a filtering value used by the to-be-filtered field, and a filtering operator. The first subfield, the second subfield, and the third subfield are introduced into the filtering condition so that the to-be-filtered field may be placed in the first subfield, the filtering value of the to-be-filtered field may be placed in the second subfield, and the filtering operator may be placed in the third subfield. The format of the filtering condition is as follows: “filters”: [{“k”:“______”, “linkType”:“______”, “v”:[“______”]}. k, v, and linkType represent the first subfield, the second subfield, and the third subfield respectively. The filtering condition in the specified data format is modeled by using the filtering condition in the preceding array structure.

The target format information of the specified data format may also include the style of the specified data format. For example, the style of the specified data format may be as follows:

{“dimensions”:[“_{——}”],“measures”:[“_{——}”],“filters”:[{“k”:“_{——}”,“linkType”:“_{——}”,“v”:
[“_{——}”]},{“k”:“_{——}”,“linkType”:“_{——}”,“v”:[“_{——}”]}]}.

The style of the specified data format is incorporated in the prompt and two filtering conditions are provided in the specified data format so that the large language model can learn not only the specified data format, but also the non-uniqueness of the filtering condition.

In the technical solution of this embodiment of the present disclosure, a dimension field, a measure field, and a filtering condition are provided in the format description of the specified data format and a filtering condition that uses an array structure is provided so that the large language model can learn the specified data format through prompt learning and convert the target query into a target format result in the specified data format.

In one or more embodiments, the method also includes acquiring at least one data record from the target data model; generating sample data for the data field based on the at least one data record; and adding the sample data of the data field to the prompt.

To facilitate learning of the data field, sample data of data fields in the target data model, especially sample data of dimensions in the target data model, can also be incorporated in the prompt. A preset number of data records may be acquired from the target data model, and sample data is generated by using the acquired data records as the dimensions. For example, sample data of data fields may be as follows:

```
  | Order Number | Region | Province | City | Product Name | Product Category | Product
Subcategory | Customer Name | Customer Type Code | Mailing Method |
  | ------ | ------ | ------ | ------ | ------ | ------ | ------ | ------ | ------ | ------ |
  | SD0020190315xxxx | Northeast | Shanghai | Qitaihe | 316 Stainless Steel Pan, Less
Oil Fume, Without Coating, Non-Stick | Office Supplies | T-Shirt | Zhang San | A | Expedited |
  | SD0020190315xxxx | East China | Yunnan | Wanning | Apple 2019 MacBook Pro 13.3
| Home Goods | Underwear | Li Si | B | Surface Mail |.
```

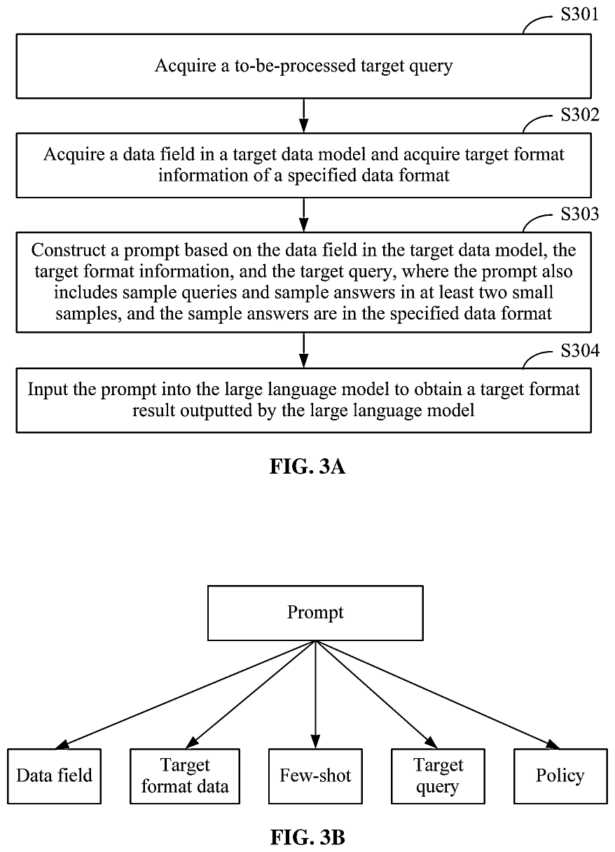

FIG. 3A is another flowchart of a query processing method based on a large language model according to an embodiment of the present disclosure. Referring to FIG. 3A, the query processing method based on a large language model according to this embodiment may include the following:

In S301, a to-be-processed target query is acquired.

In S302, a data field in a target data model is acquired, and target format information of a specified data format is acquired.

In S303, a prompt is constructed based on the data field in the target data model, the target format information, and the target query. The prompt also includes sample queries and sample answers in at least two small samples. The sample answers are in the specified data format.

In S304, the prompt is input into the large language model to obtain a target format result outputted by the large language model.

FIG. 3B is a diagram illustrating the structure of a prompt according to an embodiment of the present disclosure. Referring to FIG. 3B, the prompt may include a data field in a target data model, target format information of a specified data format, a target query, and a small sample (few-shot).

Few-shot learning is a method of learning and generalization by using a small number of labeled samples, helping us solve machine learning problems when data is scarce. That is, a small sample is used for effective learning and generalization when data is scarce. The small sample is composed of a sample query and a sample answer. The sample answer is in the specified data format, that is, the sample answer is in the same data format as the to-be-output target format result. Further, the sample answer may be in the specified JSON format. Small samples are incorporated in the prompt so that the large language model can learn from a few sample queries and sample answers, thereby enhancing the quality of the target format result outputted by the large language model.

In one or more embodiments, fields in the sample answers are randomly selected from data fields of the target data model.

Sample answers are constructed from some dimensions and some measures randomly selected from the dimensions and measures of the target data model, but not generated from fixed dimensions and fixed measures, thereby improving the coverage of few-shot learning and enhancing the performance of the large language model.

At least one of the sample answers includes a dimension field, a measure field, and a filtering condition. At least one of the sample answers lacks at least one of the dimension field, the measure field, or the filtering condition.

The configuration in which at least one sample answer includes the dimension field, the measure field, and the filtering condition in the specified data format, that is, at least one sample answer has the complete specified data format, and at least one sample answer lacks at least one of the dimension field, the measure field, or the filtering condition enables the large language model to learn that the dimension field, the measure field, and the filtering condition are not fields that must be returned and learn that it is all right to return fields other than the missing field. For example, if the filtering condition is missing, it is all right to return only the dimension field and the measure field. A sample answer lacking at least one of the dimension field, the measure field, or the filtering condition is provided so that the flexibility of the target format result can be improved.

In one or more embodiments, in response to a data dimension of a date type being present in the target data model, a first subfield in a filtering condition of at least one of the sample answers is of the date type.

If a data dimension of a date type exists in the data model, at least one small sample having a date-type dimension as the to-be-filtered field may be provided, thereby improving the effect of learning the date-type dimension by the large language model.

In one or more embodiments, in response to a data dimension of a geographic location type being present in the target data model, a first subfield in a filtering condition of at least one of the sample answers is of the geographic location type.

If a data dimension of a geographic location type exists in the data model, at least one small sample having a geographic-location-type dimension as the to-be-filtered field may be provided, thereby improving the effect of learning the geographic-location-type dimension by the large language model.

In the technical solution of this embodiment of the present disclosure, the small sample is incorporated in the prompt so that the large language model can learn from a few sample queries and sample answers, thereby enhancing the quality of the target format result outputted by the large language model.

In one or more embodiments, the prompt also includes at least one of the following policies: a time policy, a sample data policy, or a field policy. The time policy is configured for, in a case where time description information is included in the target query, processing the time description information into target time according to the current time and placing the target time into a filtering condition of the target format result. The sample data policy is configured for, in a case where sample data of any data field is included in a filtering condition of the target format result and the sample data of the data field is absent from the target query, removing the sample data of the data field from the filtering condition of the target format result by filtration. The field policy is configured for controlling a to-be-filtered field of a filtering condition in the target format result to be the same as the data field in the target data model.

Referring to FIG. 3B, the prompt may include a data field in a target data model, target format information of a specified data format, a target query, a small sample, and a policy (also called consideration). The considerations are incorporated in the prompt to better constrain the specified data format, thereby enhancing the quality of the target format result outputted by the large language model.

The time policy is used to, for the target query having the time description information, process the time description information into the target time according to the current time and place the target time into a filtering condition, thereby enhancing the ability of the large language model to learn the time description information. For example, the time policy may be as follows: The current time is xx year/xx month/xx day. For the related words such as this month, this week, last week, last month, this quarter, this year, this quarter, this Q, Q1, and Q2 present in the user's query, it is required to calculate the date based on the current time and place the calculated date in the filtering condition “filters”.

The sample data policy is configured for, in the case where sample data of any data field exists in a filtering condition of the target format result and the sample data of the data field is absent from the target query, removing the sample data of the data field from the filtering condition by filtration, thereby improving the quality of the filtering condition. For example, the sample data policy may be as follows: If the value of the dimension sample data is not present in the user's query, it is required not to place the sample data information in the filtering condition “filters” of the returned result.

The field policy is configured for ensuring that the name of a to-be-filtered field in the filtering condition and the name of a data field in the target data model are consistent so that the to-be-filtered field can hit the data field in the target data model, thereby improving the quality of the to-be-filtered field and facilitating subsequently querying the target data model based on the to-be-filtered field to obtain the answer to the target query. For example, the field policy may be as follows: The field “k” in “filters” must be the same as the name of the data dimension or data measure in the target data model.

The prompt may also include a numerical value policy. The numerical value policy is configured for converting data content in the target query into the numerical format, thereby enhancing the ability of the large language model to learn data. For example, the numerical value policy may be as follows: The data summarized in the query is required to be converted into a number. For example, 10 thousand is required to be converted into 10,000. The data content mentioned in the query is required to be converted into a numerical value.

FIG. 4 is a block diagram of a prompt according to an embodiment of the present disclosure. Referring to FIG. 4, the prompt may include a data field in a target data model, sample data of the data field, target format information, a policy, few-shot, and a target query.

Referring to FIG. 4, for a data field (field schema information), since the data field is generally stored in the database by using an English name, a mapping between the English name of the data field and the Chinese name of the data field may be obtained by acquiring the field description in the data model layer or by giving the data field a Chinese name; and the Chinese name of the data field is used in the prompt for description so that a subsequent query can use the Chinese name.

In the absence of sample data of the data field in the prompt, if the query [what is the sales amount in Shanghai] is asked, the large language model may incorrectly place Shanghai in the region dimension, causing a parsing error. After sample data of the data field is introduced into the prompt and the large language model is told the name of the data field represented by the sample data, the large language model performs reasoning and learning according to the sample data. For example, when the sales amount in “Shijiazhuang” is asked, the large language model may perform reasoning according to the given sample data and return the “city” dimension, increasing the accuracy of the target format result. In addition, if the target query includes the sample data of the data field, the accuracy of the target format result can be increased.

The format description of the specified data format in the target format information is used for informing the large language model about the format of the output data, from which information the field in the specified data format is required to be acquired, and the composition of the filtering condition. The target format information may also include the style of the specified data format so that the result format returned by the large language model can be fixed, facilitating parsing the target format result subsequently.

Regarding the considerations, at least one of the following applies:

A. The large language model is not very sensitive to time description information. The large language model can enhance the ability to learn time description information by adding the current date to the considerations and informing the large language model of some possible time description information and of the need to process the time description information. For example, when a user asks “What was the sales amount in Hebei Province last year?”, the large language model is required to parse the time description information “last year” into “2022 Jan. 1 to 2022 Dec. 31” and place the parsing result in the filtering condition.

B. If the sample data in the data dimension is not present in the to-be-processed target query, the sample data is required not to be placed in “filters” of the returned result. By this processing, data not related to the target query can be prevented from being present in the filtering condition.

C. The first subfield in the filtering condition must be strictly the same as the name of the data dimension or data measure in the target data model. For example, for the target query “What is the sales amount in Hebei”, if the target data model does not have the field “sales amount” and has the field “amount”, description is added here to express that it is expected to look for, by reasoning at the time of return, similar data dimension or data measure and use the similar data dimension or data measure as the first subfield in the filtering condition.

D. The data content summarized in the target query is required to be converted into an array. For example, for the target query “Which products have a sales amount greater than 10,000?”, the large language model may return 10 thousand as the value of the filtering condition. However, what is required is the numerical value 10,000. Therefore, this should be described in the considerations.

Regarding a small sample, the dimension and the measure in the sample answer of the small sample may be randomly acquired from the target data model and are not fixed. The details are as follows:

A. Regarding a small sample of the date type, in the case where the dimension field in the target data model has a date field and a date time type field, a small sample of the date type may be added. The corresponding small sample may be as follows:

Query: sales amount in January this year
Answer: {“dimensions”:[ ],“measures”:[“sales amount”],“filters”:[{“k”:“order
date”,“linkType”:“between”,“v”:[“2023-01-01”,“2023-01-31”]}]}.

B. Regarding a small sample of the geographic location type, if the data dimension of the geographic location type is present in the target data model, a small sample of the geographic location type may be added. The corresponding small sample may be as follows:

```
  Query: Show me the sales amount in the province of Shanghai.
  Answer: {“dimensions”:[“province”],“measures”:[“sales
amount”],“filters”:[{“k”:“province”,“linkType”:“=”,“v”:“Shanghai”}]}.
```

C. The filtering condition is not a field that must be returned. Only the dimension and measure can be returned without a filtering condition. The corresponding small sample may be as follows:

Query: sales amount in each city
Answer: {“dimensions”:[“city”],“measures”:[“sales amount”]}.

The filtering condition exists in two of the preceding three small samples, thereby increasing the learning weight of the filtering condition.

In view of the preceding, using the target query “What is the sales amount in each province of the North China?” as an example, the constructed prompt is as follows:

Please extract corresponding information from the data dimension and data measure according to the user's query:

Schema data dimension fields include the following: order number, order date, region, province, city, product name, product category, product subcategory, customer name, customer type code, shipping date, mailing method, region group, bucket, custom bucket, and numeric grouping test.

Data measurement fields include quantity, sales amount, cost, test, test count, and profit.

Sample data of the dimension for increasing the accuracy is as follows:

```
  | Order Number | Region | Province | City | Product Name | Product Category | Product
Subcategory | Customer Name | Customer Type Code | Mailing Method |
  | ------ | ------ | ------ | ------ | ------ | ------ | ------ | ------ | ------ | ------ |
  | SD0020190315xxxx | Northeast | Shanghai | Qitaihe | 316 Stainless Steel Pan, Less
Oil Fume, Without Coating, Non-Stick | Office Supplies | T-Shirt | Zhang San | A | Expedited |
  | SD0020190315xxxx | East China | Yunnan | Wanning | Apple 2019 MacBook Pro 13.3
| Home Goods | Underwear | Li Si | B | Surface Mail |
  | SD0020190315xxxx | Central China | Inner Mongolia | Sanya | A-Brand Wardrobe-1.6
m/1.8 m Storage Cabinet | Home Appliances | Kitchenware | Wang Er | C | Standard Mailing |
  | SD0020190315xxxx | North China | Beijing | Sanming | BABAMA Original Trendy
Wool Hat Hip-Hop Hat for Men | Clothing | Jacket | Armor | Undefined | Express |
  | SD0020190315xxxx| South China | Jilin | Sansha | Baleno Short-Sleeved T-shirt for
Men | Undefined | Furniture | B | Undefined | Undefined |.
```

The output content is in the JSON format. The user's query is parsed. The dimension parsed out is placed in “dimensions”. The measure parsed out is placed in “measures”.

The filtering condition parsed out is placed in “filters”. “filters” is an array. “filters” corresponds to multiple filtering conditions. Each filtering condition contains three fields: “k”, “v”, and “linkType”. “k” indicates the to-be-filtered dimension or measure. “v” indicates the value of the filtering condition. “linkType” indicates the operator of the filtering condition. Currently, the following operators are supported: greater than (>), less than (<), equal to (=), not equal to (!=), within an interval (between), and containing (in).

### Considerations:

1. The current time is 2023 Jun. 27. For the related words such as this month, this week, last week, last month, this quarter, this year, this quarter, this Q, Q1, and Q2 present in the user's query, it is required to calculate the date based on the current time and place the calculated date in “filters”.

2. If the value of the sample data of the dimension is not present in the user's query, it is required not to place the sample data information in the “filters” of the returned result.

3. The field “k” in “filters” must strictly match the name of the data dimension or data measure field.

4. The data summarized in the query is required to be converted into a number. For example, 10 thousand is required to be converted into 10,000. The number mentioned in the query is required to be converted into data.

The format of the output is generally as follows:

```
{“dimensions”:[“_{——}”],“measures”:[“_{——}”],“filters”:[{“k”:“_{——}”,“linkType”:“_{——}”,“v”:[“_{——}”]},
{“k”:“_{——}”,“linkType”:“_{——}”,“v”:[“_{——}”]}]}.
  Query: sales amount in January this year
  Answer: {“dimensions”:[ ],“measures”:[“sales amount”],“filters”:[{“k”:“order
date”,“linkType”:“between”,“v”:[“2023-01-01”,“2023-01-31”]}]}
  Query: Show me the sales amount in the province of Shanghai.
  Answer: {“dimensions”:[“province”],“measures”:[“sales
amount”],“filters”:[{“k”:“province”,“linkType”:“=”,“v”:“Shanghai”}]}
  Query: sales amount in each city
  Answer: {“dimensions”:[“city”],“measures”:[“sales amount”]}
```

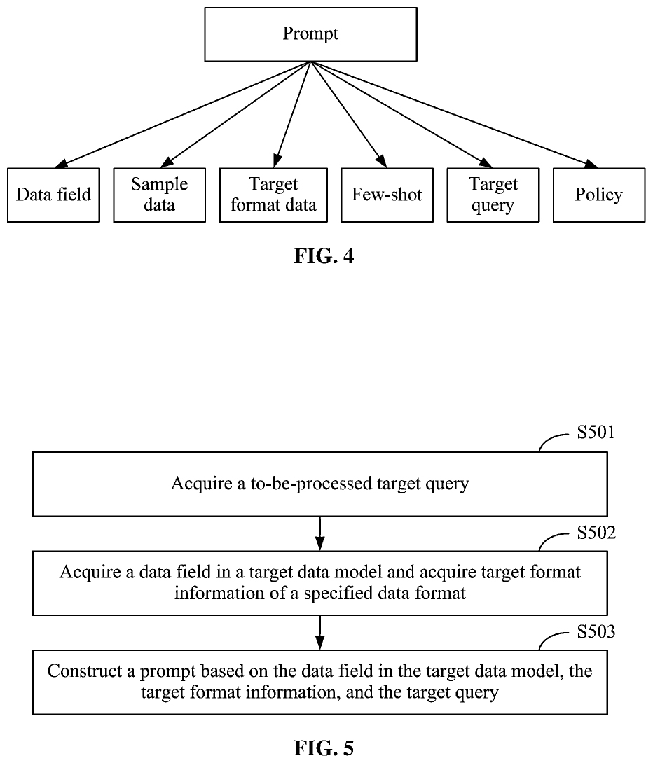

FIG. 5 is a flowchart of a prompt construction method according to an embodiment of the present disclosure. The method is applicable to prompt engineering of a large language model. The method may be executed by a prompt construction apparatus. The apparatus may be implemented by software and/or hardware and integrated into an electronic device. As shown in FIG. 5, the prompt construction method of this embodiment may include the following:

In S501, a to-be-processed target query is acquired.

In S502, a data field in a target data model is acquired, and target format information of a specified data format is acquired.

In S503, a prompt is constructed based on the data field in the target data model, the target format information, and the target query.

In one or more embodiments, the target format result is configured for establishment of a relationship between the target query and the data field in the target data model, and the target format result is a serialized result.

In one or more embodiments, the target format information includes a preset dimension field, a preset measure field, and a preset filtering condition, and is used for placing a target dimension hit by the target query in the target data model into the dimension field, placing a target measure hit by the target query in the target data model into the measure field, and placing a to-be-filtered field in the target query into the filtering condition.

In one or more embodiments, the filtering condition uses an array structure, and the filtering condition comprises a preset first subfield, a preset second subfield, and a preset third subfield. The first subfield is configured to represent the to-be-filtered field, the second subfield is configured to represent a filtering value of the to-be-filtered field, and the third subfield is configured to represent an operator of the filtering condition.

In one or more embodiments, the prompt construction method also includes acquiring at least one data record from the target data model; generating sample data for the data field based on the at least one data record; and adding the sample data of the data field to the prompt.

In one or more embodiments, the prompt also includes sample queries and sample answers in at least two small samples, and the sample answers are in the specified data format.

In one or more embodiments, fields in the sample answers are randomly selected from the data fields of the target data model.

In one or more embodiments, at least one of the sample answers includes a dimension field, a measure field, and a filtering condition; and at least one of the sample answers lacks at least one of the dimension field, the measure field, or the filtering condition.

In one or more embodiments, if a data dimension of a date type exists in the target data model, a first subfield in a filtering condition of at least one of the sample answers is of the date type.

In one or more embodiments, if a data dimension of a geographic location type exists in the target data model, a first subfield in a filtering condition of at least one of the sample answers is of the geographic location type.

In one or more embodiments, the prompt includes at least one of the following policies: a time policy, a sample data policy, or a field policy.

The time policy is configured for, in a case where time description information is present in the target query, processing the time description information into target time according to the current time and placing the target time into a filtering condition of the target format result.

The sample data policy is configured for, in a case where sample data of any data field is present in a filtering condition of the target format result and the sample data of the data field is absent from the target query, removing the sample data of the data field from the filtering condition of the target format result by filtration.

The field policy is configured for controlling a to-be-filtered field of a filtering condition in the target format result to be the same as the data field in the target data model.

In the technical solution of this embodiment of the present disclosure, an engineered prompt is constructed so that the large language model can learn through the provided prompt and output a fixed JSON format. That is, a switch between the large language model and the JSON is achieved. This switch is called NL2JSON. Compared with the method of making a large language model output desired parsable JSON data by emphasizing the format of the input, the present disclosure uses systematic prompt engineering to enable a large language model to consistently understand a target query and convert the target query into a specified data format, that is, obtain a target format result in a fixed format.

FIG. 6 is a block diagram of a query processing apparatus based on a large language model according to an embodiment of the present disclosure. This embodiment is applicable to prompt engineering of a large language model. The apparatus may be implemented by software and/or hardware. As shown in FIG. 6, the query processing apparatus 600 based on a large language model according to this embodiment may include a query acquisition module 610, a field format module 620, a prompt module 630, and a result module 640.

The query acquisition module 610 is configured to acquire a to-be-processed target query.

The field format module 620 is configured to acquire a data field in a target data model and acquire target format information of a specified data format.

The prompt module 630 is configured to construct a prompt based on the data field in the target data model, the target format information, and the target query.

The result module 640 is configured to input the prompt into the large language model to obtain a target format result outputted by the large language model.

In one or more embodiments, the target format result is configured for establishment of a relationship between the target query and the data field in the target data model, and the target format result is a serialized result.

In one or more embodiments, the target format information includes a preset dimension field, a preset measure field, and a preset filtering condition. The dimension field is configured to store a target dimension hit by the target query in the target data model. The measure field is configured to store a target measure hit by the target query in the target data model. The filtering condition is configured to store a to-be-filtered field in the target query.

In one or more embodiments, the filtering condition uses an array structure, and the filtering condition comprises a preset first subfield, a preset second subfield, and a preset third subfield, wherein the first subfield is configured to represent the to-be-filtered field, the second subfield is configured to represent a filtering value of the to-be-filtered field, and the third subfield is configured to represent an operator of the filtering condition.

In one or more embodiments, the query processing apparatus 600 based on a large language model also includes a sample data module. The sample data module includes a record acquisition unit, a sample generation unit, and a sample addition unit.

The record acquisition unit is configured to acquire at least one data record from the target data model.

The sample generation unit is configured to generate sample data for the data field based on the at least one data record.

The sample addition unit is configured to add the sample data of the data field to the prompt.

In one or more embodiments, the prompt also includes sample queries and sample answers in at least two small samples, wherein the sample answers are in the specified data format.

In one or more embodiments, fields in the sample answers are randomly selected from data fields of the target data model.

In one or more embodiments, at least one of the sample answers includes a dimension field, a measure field, and a filtering condition; and at least one of the sample answers lacks at least one of the dimension field, the measure field, or the filtering condition.

In one or more embodiments, in response to a data dimension of a date type being present in the target data model, a first subfield in a filtering condition of at least one of the sample answers is of the date type.

In one or more embodiments, in response to a data dimension of a geographic location type being present in the target data model, a first subfield in a filtering condition of at least one of the sample answers is of the geographic location type.

In one or more embodiments, the prompt includes at least one of the following policies: a time policy, a sample data policy, or a field policy.

The time policy is configured for, in response to time description information being present in the target query, processing the time description information into target time according to the current time and placing the target time into a filtering condition of the target format result.

The sample data policy is configured for, in response to sample data of any data field being present in a filtering condition of the target format result and in response to the sample data of the data field being absent from the target query, removing the sample data of the data field from the filtering condition of the target format result by filtration.

The field policy is configured for controlling a to-be-filtered field of a filtering condition in the target format result to be the same as the data field in the target data model.

In the technical solution of this embodiment of the present disclosure, an engineered prompt is constructed so that the large language model can learn through the provided prompt and output a fixed JSON format. That is, a switch of the large language model to JSON is achieved. This switch is called NL2JSON. Compared with the method of making a large language model output desired parsable JSON data by emphasizing the format of the input, the present disclosure uses systematic prompt engineering to enable a large language model to consistently understand a target query and convert the target query into a specified data format, that is, obtain a target format result in a fixed format.

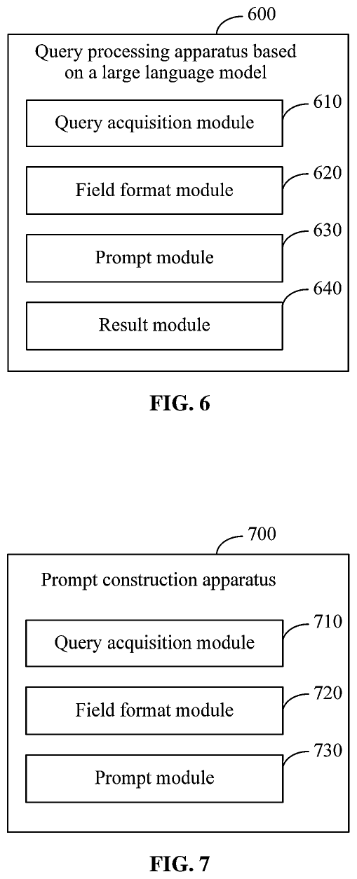

FIG. 7 is a block diagram of a query processing apparatus based on a large language model according to an embodiment of the present disclosure. This embodiment is applicable to prompt engineering of a large language model. The apparatus may be implemented by software and/or hardware. As shown in FIG. 7, the query processing apparatus 700 of this embodiment may include a query acquisition module 710, a field format module 720, and a prompt module 730.

The query acquisition module 710 is configured to acquire a to-be-processed target query.

The field format module 720 is configured to acquire a data field in a target data model and acquire target format information of a specified data format.

The prompt module 730 is configured to construct a prompt based on the data field in the target data model, the target format information, and the target query.

In one or more embodiments, the target format result is configured for establishment of a relationship between the target query and the data field in the target data model, and the target format result is a serialized result.

In one or more embodiments, the target format information includes a preset dimension field, a preset measure field, and a preset filtering condition. The dimension field is configured to store a target dimension hit by the target query in the target data model. The measure field is configured to store a target measure hit by the target query in the target data model. The filtering condition is configured to store a to-be-filtered field in the target query.

In one or more embodiments, the filtering condition uses an array structure, the filtering condition comprises a preset first subfield, a preset second subfield, and a preset third subfield, the first subfield is configured to represent the to-be-filtered field, the second subfield is configured to represent a filtering value of the to-be-filtered field, and the third subfield is configured to represent an operator of the filtering condition.

In one or more embodiments, the query processing apparatus 600 based on a large language model also includes a sample data module. The sample data module includes a record acquisition unit, a sample generation unit, and a sample addition unit.

The record acquisition unit is configured to acquire at least one data record from the target data model.

The sample generation unit is configured to generate sample data for the data field based on the at least one data record.

The sample addition unit is configured to add the sample data of the data field to the prompt.

In one or more embodiments, the prompt also includes sample queries and sample answers in at least two small samples, and the sample answers are in the specified data format.

In one or more embodiments, fields in the sample answers are randomly selected from data fields of the target data model.

In one or more embodiments, at least one of the sample answers includes a dimension field, a measure field, and a filtering condition; and at least one of the sample answers lacks at least one of the dimension field, the measure field, or the filtering condition.

In one or more embodiments, if a data dimension of a date type is present in the target data model, a first subfield in a filtering condition of at least one of the sample answers is of the date type.

In one or more embodiments, if a data dimension of a geographic location type is present in the target data model, a first subfield in a filtering condition of at least one of the sample answers is of the geographic location type.

In one or more embodiments, the prompt includes at least one of the following policies: a time policy, a sample data policy, or a field policy.

The time policy is configured for, in response to time description information being present in the target query, processing the time description information into target time according to current time and placing the target time into a filtering condition of the target format result.

The sample data policy is configured for, in response to sample data of any data field being present in a filtering condition of the target format result and the sample data of the data field being absent from the target query, removing the sample data of the data field from the filtering condition of the target format result by filtration.

The field policy is configured for controlling a to-be-filtered field of a filtering condition in the target format result to be the same as the data field in the target data model.

In the technical solution of this embodiment of the present disclosure, the hierarchical description of various parts in the prompt where each part has its own meaning and function allows the large language model to understand the meaning of the service based on the provided prompt. This enables the large language model to consistently output JSON-formatted data in the specified data format and with meaningful information, thereby making it easier for a user in engineering to parse and utilize information returned by the large language model and facilitating the engineered use of the output of the large language model.

In the technical solutions of the present disclosure, acquisition, storage and application of user personal information involved are in compliance with relevant laws and regulations and do not violate public order and good customs.

According to embodiments of the present disclosure, also provided are an electronic device, a readable storage medium, and a computer program product.

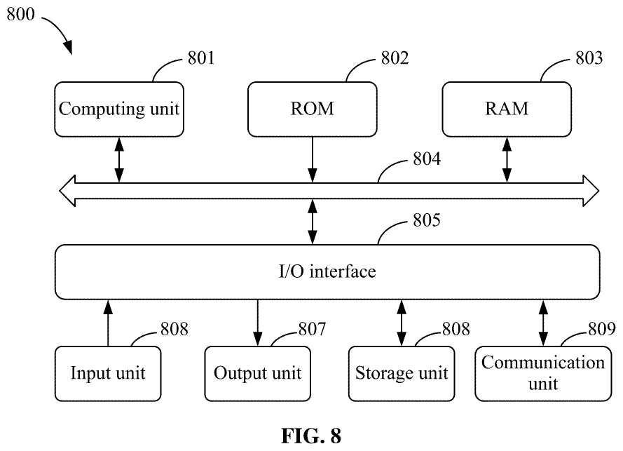

FIG. 8 is a block diagram of an electronic device for implementing a query processing method based on a large language model or a prompt construction method according to an embodiment of the present disclosure.

FIG. 8 is a block diagram illustrative of an example electronic device 800 that may be configured to implement the embodiments of the present disclosure. The electronic device is intended to represent various forms of digital computers, for example, a laptop computer, a desktop computer, a worktable, a personal digital assistant, a server, a blade server, a mainframe computer or another applicable computer. The electronic device may also represent various forms of mobile apparatuses, for example, a personal digital assistant, a cellphone, a smartphone, a wearable device or a similar computing apparatus. Herein the shown components, the connections and relationships between these components and the functions of these components are illustrative only and are not intended to limit the implementation of the present disclosure as described and/or claimed herein.

As shown in FIG. 8, the electronic device 800 includes a computing unit 801. The computing unit 802 may perform various appropriate actions and processing according to a computer program stored in a read-only memory (ROM) 802 or a computer program loaded into a random-access memory (RAM) 803 from a storage unit 808. Various programs and data required for the operation of the electronic device 800 are also stored in the RAM 803. The computing unit 801, the ROM 802 and the RAM 803 are connected to each other through a bus 804. An input/output (I/O) interface 805 is also connected to the bus 804.

Multiple components in the electronic device 800 are connected to the I/O interface 805. The multiple components include an input unit 806 such as a keyboard or a mouse, an output unit 807 such as various types of displays or speakers, the storage unit 808 such as a magnetic disk or an optical disk, and a communication unit 809 such as a network card, a modem or a wireless communication transceiver. The communication unit 809 allows the electronic device 800 to exchange information/data with other devices over a computer network such as the Internet and/or various telecommunications networks.

The computing unit 801 may be various general-purpose and/or special-purpose processing components having processing and computing capabilities. Examples of the computing unit 801 include, but are not limited to, a central processing unit (CPU), a graphics processing unit (GPU), a special-purpose artificial intelligence (AI) computing chip, a computing unit executing machine learning models and algorithms, a digital signal processor (DSP), and any appropriate processor, controller and microcontroller. The computing unit 801 executes various methods and processing described above, such as the query processing method based on a large language model or the prompt construction method. For example, in some embodiments, the query processing method based on a large language model or the prompt construction method may be implemented as a computer software program tangibly contained in a machine-readable medium such as the storage unit 808. In some embodiments, part or all of computer programs may be loaded and/or installed onto the electronic device 800 via the ROM 802 and/or the communication unit 809. When the computer programs are loaded into the RAM 803 and executed by the computing unit 801, one or more steps of the query processing method based on a large language model or the prompt construction method may be performed. Alternatively, in other embodiments, the computing unit 801 may be configured, in any other suitable manner (for example, by means of firmware), to execute the query processing method based on a large language model or the prompt construction method.

Herein various embodiments of the preceding systems and techniques may be implemented in digital electronic circuitry, integrated circuitry, field-programmable gate arrays (FPGAs), application-specific integrated circuits (ASICs), application-specific standard products (ASSPs), systems on chips (SoCs), complex programmable logic devices (CPLDs), computer hardware, firmware, software and/or combinations thereof. The various embodiments may include implementations in one or more computer programs. The one or more computer programs are executable and/or interpretable on a programmable system including at least one programmable processor. The at least one programmable processor may be a special-purpose or general-purpose programmable processor for receiving data and instructions from a memory system, at least one input apparatus and at least one output apparatus and transmitting data and instructions to the memory system, the at least one input apparatus and the at least one output apparatus.

Program codes for implementation of the methods of the present disclosure may be written in one programming language or any combination of multiple programming languages. These program codes may be provided for the processor or controller of a general-purpose computer, a special-purpose computer or another programmable data processing apparatus to cause functions/operations specified in flowcharts and/or block diagrams to be implemented when the program codes are executed by the processor or controller. The program codes may be executed entirely on a machine, partly on a machine, as a stand-alone software package, partly on a machine and partly on a remote machine, or entirely on a remote machine or a server.

In the context of the present disclosure, a machine-readable medium may be a tangible medium that may include or store a program that can be used by or in connection with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared or semiconductor system, apparatus or device, or any suitable combination thereof. More specific examples of the machine-readable storage medium may include an electrical connection based on one or more wires, a portable computer disk, a hard disk, a random-access memory (RAM), a read-only memory (ROM), an erasable programmable read-only memory (EPROM) or a flash memory, an optical fiber, a portable compact disc read-only memory (CD-ROM), an optical storage device, a magnetic storage device or any appropriate combination thereof.

In order that interaction with a user is provided, the systems and techniques described herein may be implemented on a computer. The computer has a display device (for example, a cathode-ray tube (CRT) or a liquid-crystal display (LCD) monitor) for displaying information to the user and a keyboard and a pointing apparatus (for example, a mouse or a trackball) through which the user can provide input to the computer. Other types of devices may also be used for providing interaction with a user. For example, feedback provided for the user may be sensory feedback in any form (for example, visual feedback, auditory feedback or haptic feedback). Moreover, input from the user may be received in any form (including acoustic input, voice input or haptic input).

The systems and techniques described herein may be implemented in a computing system including a back-end component (for example, a data server), a computing system including a middleware component (for example, an application server), a computing system including a front-end component (for example, a client computer having a graphical user interface or a web browser through which a user can interact with implementations of the systems and techniques described herein) or a computing system including any combination of such back-end, middleware or front-end components. Components of a system may be interconnected by any form or medium of digital data communication (for example, a communication network). Examples of the communication network include a local area network (LAN), a wide area network (WAN), and the Internet.

A computer system may include clients and servers. A client and a server are generally remote from each other and typically interact through a communication network. The relationship between the clients and the servers arises by virtue of computer programs running on respective computers and having a client-server relationship to each other. A server may be a cloud server, a server of a distributed system, or a server combined with a blockchain.

Artificial intelligence is a discipline studying the simulation of certain human thinking processes and intelligent behaviors (such as learning, reasoning, thinking and planning) by a computer and involves techniques at both hardware and software levels. Hardware techniques of artificial intelligence generally include techniques such as sensors, special-purpose artificial intelligence chips, cloud computing, distributed storage and big data processing. Software techniques of artificial intelligence mainly include several major directions such as computer vision technology, speech recognition technology, natural language processing technology, machine learning/deep learning technology, big data processing technology and knowledge graph technology.

Cloud computing refers to a technical system that accesses a shared elastic-and-scalable physical or virtual resource pool through a network and can deploy and manage resources in an on-demand self-service manner, where the resources may include servers, operating systems, networks, software, applications, storage devices and the like. Cloud computing can provide efficient and powerful data processing capabilities for model training and technical applications such as artificial intelligence and blockchain.

It is to be understood that various forms of the preceding flows may be used with steps reordered, added or removed. For example, the steps described in the present disclosure may be executed in parallel, in sequence, or in a different order as long as the desired results of the technical solutions disclosed in the present disclosure are achieved. The execution sequence of these steps is not limited herein.

The scope of the present disclosure is not limited by the preceding embodiments. It is to be understood by those skilled in the art that various modifications, combinations, sub-combinations and substitutions may be made according to design requirements and other factors. Any modification, equivalent substitution and improvement made within the spirit and principle of the present disclosure is within the scope of the present disclosure.

What is claimed:

1. A query processing method based on a large language model, comprising:
acquiring a to-be-processed target query;
acquiring a data field in a target data model and acquiring target format information of a specified data format;
constructing a prompt based on the data field in the target data model, the target format information, and the to-be-processed target query; and
inputting the prompt into the large language model to obtain a target format result outputted by the large language model.

2. The query processing method based on the large language model of claim 1, wherein the target format result is configured for establishment of a relationship between the to-be-processed target query and the data field in the target data model, and the target format result is a serialized result.

3. The query processing method based on the large language model of claim 1, wherein the target format information comprises a preset dimension field, a preset measure field, and a preset filtering condition, and the target format information is configured for placing a target dimension hit by the to-be-processed target query in the target data model into the preset dimension field, placing a target measure hit by the to-be-processed target query in the target data model into the preset measure field, and placing a to-be-filtered field in the to-be-processed target query into the preset filtering condition.

4. The query processing method based on the large language model of claim 3, wherein the preset filtering condition uses an array structure, and the preset filtering condition comprises a preset first subfield, a preset second subfield, and a preset third subfield, wherein the preset first subfield is configured to represent the to-be-filtered field, the preset second subfield is configured to represent a filtering value of the to-be-filtered field, and the preset third subfield is configured to represent an operator of the preset filtering condition.

5. The query processing method based on the large language model of claim 1, further comprising:
acquiring at least one data record from the target data model;
generating sample data for the data field based on the at least one data record; and
adding the sample data of the data field to the prompt.

6. The query processing method based on the large language model of claim 1, wherein the prompt further comprises sample queries and sample answers in at least two small samples, wherein the sample answers are in the specified data format.

7. The query processing method based on the large language model of claim 6, wherein fields in the sample answers are randomly selected from data fields of the target data model.

8. The query processing method based on the large language model of claim 6, wherein at least one of the sample answers comprises a dimension field, a measure field, and a filtering condition; and at least one of the sample answers lacks at least one of the dimension field, the measure field, or the filtering condition.

9. The query processing method based on the large language model of claim 6, wherein:
in response to the target data model comprising a data dimension of a date type, a first subfield in a filtering condition of at least one of the sample answers is of the date type.

10. The query processing method based on the large language model of claim 6, wherein:
in response to the target data model comprising a data dimension of a geographic location type, a first subfield in a filtering condition of at least one of the sample answers is of the geographic location type.

11. The query processing method based on the large language model of claim 1, wherein the prompt comprises at least one of following policies:
a time policy configured for, in response to the to-be-processed target query comprising time description information, processing the time description information into target time according to current time and placing the target time into a filtering condition of the target format result;
a sample data policy configured for, in response to a filtering condition of the target format result comprising sample data of a data field and the sample data of the data field being absent from the to-be-processed target query, removing the sample data of the data field from the filtering condition of the target format result by filtration; or
a field policy configured for controlling a to-be-filtered field of a filtering condition in the target format result to be same as the data field in the target data model.

12. A prompt construction method, comprising:
acquiring a to-be-processed target query;
acquiring a data field in a target data model, and acquiring target format information of a specified data format; and
constructing a prompt based on the data field in the target data model, the target format information, and the to-be-processed target query.

13-24. (canceled)

25. An electronic device, comprising:
at least one processor; and
a memory communicatively connected to the at least one processor,
wherein the memory stores instructions executable by the at least one processor to enable the at least one processor to perform the following:
acquiring a to-be-processed target query;
acquiring a data field in a target data model and acquiring target format information of a specified data format;
constructing a prompt based on the data field in the target data model, the target format information, and the to-be-processed target query; and
inputting the prompt into a large language model to obtain a target format result outputted by the large language model.

26. A non-transitory computer-readable storage medium storing computer instructions, wherein the computer instructions are configured to cause a computer to perform the method of claim 1.

27. The electronic device of claim 25, wherein the target format result is configured for establishment of a relationship between the to-be-processed target query and the data field in the target data model, and the target format result is a serialized result.

28. The electronic device of claim 25, wherein the target format information comprises a preset dimension field, a preset measure field, and a preset filtering condition, and the target format information is configured for placing a target dimension hit by the to-be-processed target query in the target data model into the preset dimension field, placing a target measure hit by the to-be-processed target query in the target data model into the measure field, and placing a to-be-filtered field in the to-be-processed target query into the preset filtering condition.

29. The electronic device of claim 28, wherein the preset filtering condition uses an array structure, and the preset filtering condition comprises a preset first subfield, a preset second subfield, and a preset third subfield, wherein the preset first subfield is configured to represent the to-be-filtered field, the preset second subfield is configured to represent a filtering value of the to-be-filtered field, and the preset third subfield is configured to represent an operator of the preset filtering condition.

30. The electronic device of claim 25, wherein the at least one processor is enabled to further perform:
acquiring at least one data record from the target data model;
generating sample data for the data field based on the at least one data record; and
adding the sample data of the data field to the prompt.

31. The electronic device of claim 25, wherein the prompt further comprises sample queries and sample answers in at least two small samples, wherein the sample answers are in the specified data format.

32. The electronic device of claim 31, wherein fields in the sample answers are randomly selected from data fields of the target data model.
